(19) United States
(12) Patent Application Publication
(10) Pub. No.: US 2024/0354548 A1
(43) Pub. Date: Oct. 24, 2024

(54) Energy-Efficient Recurrent Neural Network Accelerator

(71) Applicant: Taiwan Semiconductor Manufacturing Company, Ltd., Hsinchu (TW)

(72) Inventors: Kerem Akarvardar, Hsinchu (TW); Yu-Der Chih, Hsinchu (TW); Xiaoyu Sun, Hsinchu (TW)

(21) Appl. No.: 18/302,154

(22) Filed: Apr. 18, 2023

(51) Int. Cl. G06N 3/0442; G06N 3/048

(52) U.S. Cl. CPC G06N 3/0442; G06N 3/048

(57) ABSTRACT

Systems and methods are provided for a neural network that includes a multiply accumulate (MAC) unit that is configured to receive an input vector weight matrix; multiply the input matrix by the input vector weight matrix, generating input vector partial sums; receive time-delayed hidden vectors and a hidden vector weight matrix; and multiply the time-delayed hidden vectors and the hidden vector weight matrix, which generates hidden vector partial sums. An accumulator may be coupled to the MAC unit and configured to accumulate and add the input vector partial sums and the hidden vector partial sums, generating full sum vectors. The neural network may generate the time-delayed hidden vectors based on the full sum vectors. The neural network may further include a first selection device coupled to the MAC unit that is configured to select between the input matrix and the time-delayed hidden vectors for reception at the MAC unit.

### FIELD

The present disclosure relates to artificial neural networks and, in particular, recurrent neural networks.

### BACKGROUND

Recurrent neural networks (RNNs) are a type of artificial neural network in which outputs of some nodes (e.g., “neurons”) within the network can affect the signals subsequently received by those same nodes. Several drawbacks are associated with conventional recurrent neural networks. For example, weight reusage in conventional recurrent neural networks may be difficult or impossible. This is because the serial processing employed in recurrent neural networks results in inputs to nodes within the recurrent neural networks being available progressively at each time step, rather than all input data being available initially. This nominally leads to reloading of the same weights from the memory at each time step within a conventional recurrent neural network, which can result in undesirably high energy consumption. Therefore, there is a need in the art to minimize the movement of weight data in neural networks.

### BRIEF DESCRIPTION OF THE DRAWINGS

The following detailed description will be better understood when read in conjunction with the appended drawings. For the purpose of illustration, there is shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIG. 1A depicts a block diagram of a recurrent neural network (RNN) system in accordance with an embodiment.

FIG. 1B depicts an RNN system in accordance with an embodiment.

FIG. 2 depicts a time-unrolled RNN gate topology plot in accordance with an embodiment.

FIG. 3 depicts an RNN core 102 partitioned view based on the time dependence of the inputs in accordance with an embodiment.

FIG. 4 depicts a functional diagram of an RNN core in accordance with an embodiment.

FIG. 5 depicts an RNN core architecture in accordance with an embodiment.

FIG. 6 depicts an RNN core architecture with a control block in accordance with an embodiment.

FIG. 7 depicts a matrix multiplication numerical example in accordance with an embodiment.

FIG. 8 depicts a decomposed matrix view of a matrix multiplication in accordance with an embodiment.

FIGS. 9-23 depict steps of an RNN core operation in accordance with an embodiment.

FIG. 24 depicts a summary of an RNN core operation with batched inputs in accordance with an embodiment.

FIG. 25 depicts a flowchart of an RNN core operation with batched inputs in accordance with an embodiment.

FIG. 26 depicts a flowchart of a hardware implementation of RNN units in accordance with an embodiment.

FIGS. 27-29 depict steps in the flowchart of the hardware implementation of RNN units in accordance with an embodiment.

FIG. 30 depicts a gated recurrent unit (GRU) with RNN cores in accordance with an embodiment.

FIG. 31 depicts a method in accordance with an embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention, and be protected by the accompanying claims.

As noted above, recurrent neural networks (RNNs) are a type of artificial neural network in which outputs of some nodes (e.g., “neurons”) within the network can affect the signals subsequently received by those same nodes. In conventional RNNs, weights used in computational processes may be loaded from a memory unit into an RNN core or RNN gate several times (e.g., at each timestep). Because RNNs often involve many weights, this recurrent loading may cause undesirable increases in energy, latency, and time of RNN operations.

In embodiments, it may be desirable for an RNN to decrease the movement or loading of the RNN weights and increase the weight reusage of a single loading of the weights from the RNN memory. Embodiments disclosed herein involve increasing (e.g., maximizing) weight reusage by decreasing the movement or loading of the RNN weights by components within the RNN. In embodiments, decreasing the movement or loading of the RNN weights is accomplished by providing RNN accelerator cores (“RNN cores”) that employ methods of data mapping into the RNN core. Furthermore, the dimensions (e.g., capacity) of the RNN core components of the systems and methods disclosed herein are designed such that weights are, in some embodiments, accessed (e.g., loaded) by the RNN core from an RNN memory only once during an RNN core operation. The example embodiments disclosed herein can be implemented on an application specific integrated circuit (“ASIC”) in some instances.

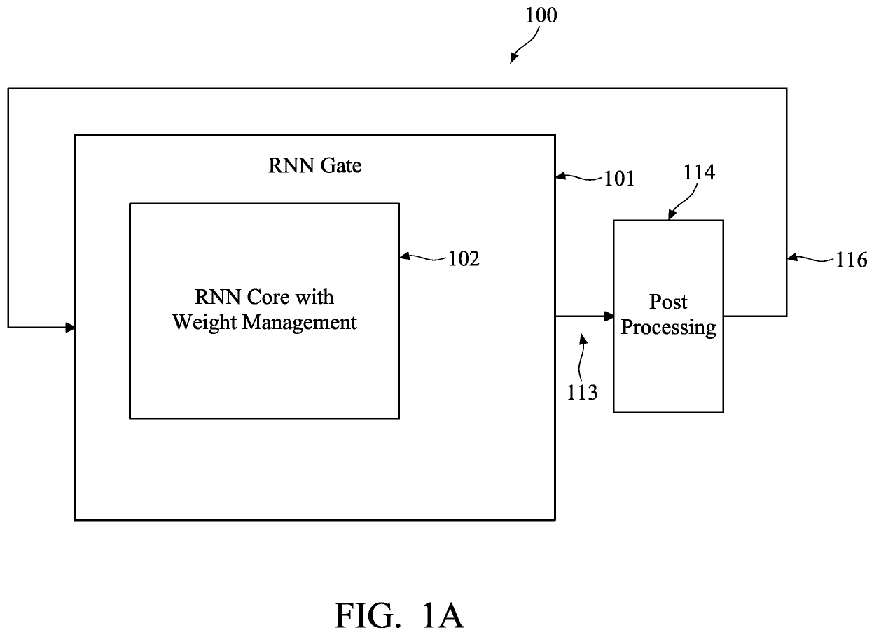

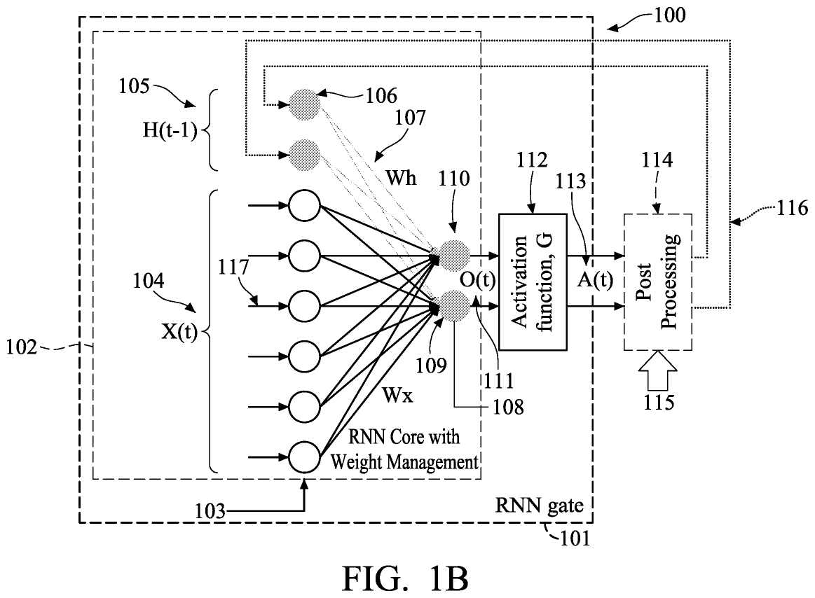

FIG. 1A depicts a block diagram of a recurrent neural network (RNN) system, in accordance with some embodiments. As depicted in FIG. 1A, the RNN system 100 includes an RNN gate 101. The RNN gate 101 includes an RNN core 102. The RNN system 100 also includes a post processing block 114 coupled to the RNN gate 101. The RNN core 102 can receive one or more RNN output signals 116. In addition, the RNN core 102 may receive one or more additional inputs (not shown) (e.g., weights and vectors) depending on the particular application for which the RNN system 100 is used. Based on the inputs received by the RNN core 102, the RNN gate 101 generates activation signals 113. The activation signals 113 are processed by the post processing block 114 to form the RNN output signals 116. As discussed above, the RNN output signals 116 are subsequently received as inputs by the RNN core 102.

FIG. 1B depicts an RNN system, in accordance with some embodiments. As depicted in FIG. 1B, the RNN system 100 includes the RNN gate 101. The RNN gate 101 comprises the RNN core 102. The RNN core 102 includes an input layer 103 that can receive one or more inputs 117 (e.g., signals). For example, the inputs 117 received by the input layer 103 may include an input vector X(t) 104 and a time-delayed hidden vector H(t−1) 105. The time-delayed hidden vector H(t−1) 105 is a hidden vector produced at a previous timestep relative to the input vector X(t) 104. The RNN core 102 further includes a hidden layer 108 that can receive the time-delayed hidden vector H(t−1) 105 and the input vector X(t) 104.

The hidden layer 108 is also configured to receive a hidden vector weight matrix Wₕ 110 including a matrix of weights for applying to the input vector X(t) 104 and time-delayed hidden vector H(t−1) 105 through matrix operations (e.g., matrix multiplication). The hidden vector weight matrix Wₕ 110 may include real numbers (e.g., weights) that are associated with the time-delayed hidden vector H(t−1) 105 and are used to scale values of the input layer output signals 107. The hidden vector weight matrix Wₕ 110 may be appropriately dimensioned for performing the one or more operations on the time-delayed hidden vector H(t−1) 105. For example, the dimensions of the hidden vector weight matrix Wₕ 110 may be h×h, where h is the number of hidden “neurons” (e.g., nodes) in the recurrent neural network architecture.

The hidden layer 108 may also receive an input vector weight matrix Wₓ 109 which includes a matrix of weights for performing matrix operations on the input vector X(t) 104. The input vector weight matrix Wₓ 109 may include real numbers (e.g., weights) that are associated with the input vector X(t) 104 and are used to scale values within the input vector X(t) 104. The operations performed by the hidden layer 108 on the input vector X(t) 104 and time-delayed hidden vector H(t−1) 105 may result in one or more full sums, which can be generated as one or more full sum vectors O(t) 111 by the hidden layer 108. The full sum vector O(t) 111 is characterized by equation (1) below:

$$O ( t ) = {W}_{h} \times H ( t - 1 ) + {W}_{x} \times X ( t ) + b \qquad ( 1 )$$

In equation (1) above, the hidden vector weight matrix Wₕ 110 is multiplied by the time-delayed hidden vector H(t−1) 105. This term, Wₕ×H(t−1), is added to the product of the input vector weight matrix Wₓ 109 and the input vector X(t) 104. A bias term b may be added to equation (1) to generate the full sum vector O(t) 111. The bias term b can be assumed to be zero but may be a positive or negative value in differing applications. It can be modeled by an additional neuron at the input layer with a constant input (e.g., an input of one).

The RNN gate 101 further includes an activation function block 112. In the example embodiment depicted in FIG. 1B, the activation function block 112 is located outside of the RNN core 102. However, in other example embodiments the activation function block 112 may be located within the RNN core 102. The full sum vector O(t) can be received by an activation function block 112. The activation function block 112 may apply an activation function (e.g., sigmoid or hyperbolic tangent) to the full sum vector O(t) 111. An activation function is a function defining how the weighted sum of an input to one or more nodes is transformed into an output of the one or more nodes. For example, the sigmoid function generates an output between 0 and 1, and may be useful for neural networks modeling the probability of an event as an output of one or more nodes. The hyperbolic tangent function generates an output between −1 and 1, and may be useful for neural networks in which the output of one or more nodes can be negative or positive. As a result of applying the activation function to the full sum vector O(t) 111, the activation function block 112 may generate an activation vector A(t) 113, which can be an output of the RNN gate 101. The dimensions of the activation vector A(t) 113 may be h×1. In the example embodiment of FIG. 1B, the activation vector A(t) 113 is characterized by equation (2):

$$A ( t ) = G [ {W}_{h} \times H ( t - 1 ) + {W}_{x} \times X ( t ) + b ] \qquad ( 2 )$$

In equation (2), G represents the activation function such as sigmoid or hyperbolic tangent that is performed on the full sum vector O(t) 111.

The activation vector A(t) 113 is then received by a post processing block 114 that is capable of processing the activation vector A(t) 113. For example, the post processing block 114 may be capable of applying a digital filter, a buffer, or a function to the activation vector A(t) 113 based on the specific application for which the recurrent neural network is being used. In addition to the activation vector A(t) 113, the post processing block 114 receives one or more extra inputs 115. These extra inputs 115 may be, for example, outputs of other RNN gates or may be functions of previously generated signals within the RNN core 102 or the RNN gate 101. The post processing block 114 then generates one or more RNN output signals 116 based on the processed activation vector A(t) 113 and any extra inputs 115. For example, the post processing block 114 may apply a digital filter or a buffer to the activation vector A(t) 113 to generate the RNN output signals 116. The RNN output signals 116 are in turn used as inputs within the time-delayed hidden vector H(t−1) 105, which is received at the input layer 103, as discussed above.

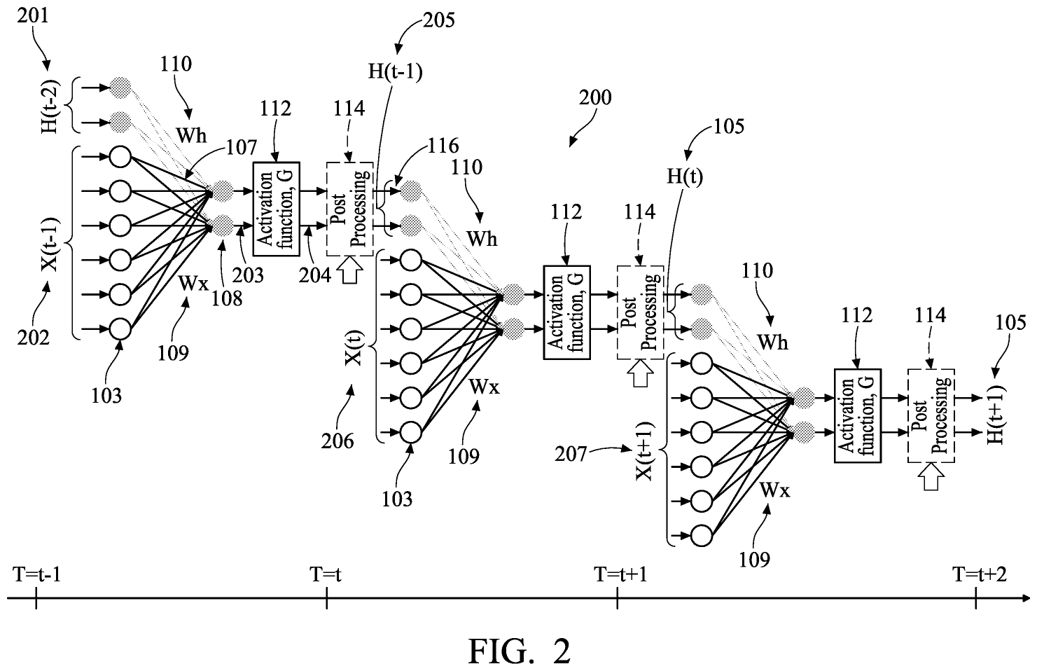

FIG. 2 depicts a time-unrolled RNN gate topology plot, in accordance with some embodiments. In the example depicted in FIG. 2, at time T=t−1 the RNN gate 101 receives a time delayed hidden vector H(t−2) 201 at the input layer 103. As discussed above with reference to FIG. 1B, this time-delayed hidden vector H(t−2) 201 may have been generated in a previous timestep relative to time T=t−1 (e.g., time T=t−2). The RNN gate 101 also receives input vector X(t−1) 202 at the input layer 103. The input vector X(t−1) 202 and the time-delayed hidden vector H(t−2) 201 are received by the hidden layer 104. The hidden layer 108 also receives the input vector weight matrix Wₓ 109 and the hidden vector weight matrix Wₕ 110, which may be vectors with constant terms. The hidden layer 108 then generates the full sum vector O(t) 203 based on the input vector X(t−1) 202, the time-delayed hidden vector H(t−2) 201, the input vector weight matrix 109, and the hidden vector weight matrix Wₕ 110.

The activation function block 112 then applies an activation function to the full sum vector O(t) 203, which produces an activation vector A(t) 204. For example, the activation function block may receive the full sum vector O(t) 203 as an input to a sigmoid function. As discussed above, the sigmoid function produces an output between 0 and 1, which can be useful for models involving probability. The activation vector A(t) 204 may then be generated as the result of the sigmoid function applied to the full sum vector O(t) 203. This activation vector A(t) 204 is then processed by the post processing block 114 which can generate the RNN output signals 116. As discussed above, the processing by the post processing block 114 may involve applying a digital filter or a buffer to the activation vector A(t) 204 to generate the RNN output signals 116. The RNN gate 101 can then receive these RNN output signals 116 as inputs to the hidden vector H(t−1) 205 at time T=t. At this time T=t, the RNN gate 101 can also receive the input vector X(t) 206. As shown in FIG. 2, the process may repeat for subsequent time steps, with RNN output signals from previous timesteps being utilized as inputs to the hidden vector H at the next timestep. The input vector weight matrix Wₓ 109 and the hidden vector weight matrix Wₕ 110 may be applied to the input vector X(t) and the time-delayed hidden vector H(t), respectively, at the hidden layer 104 for each time step.

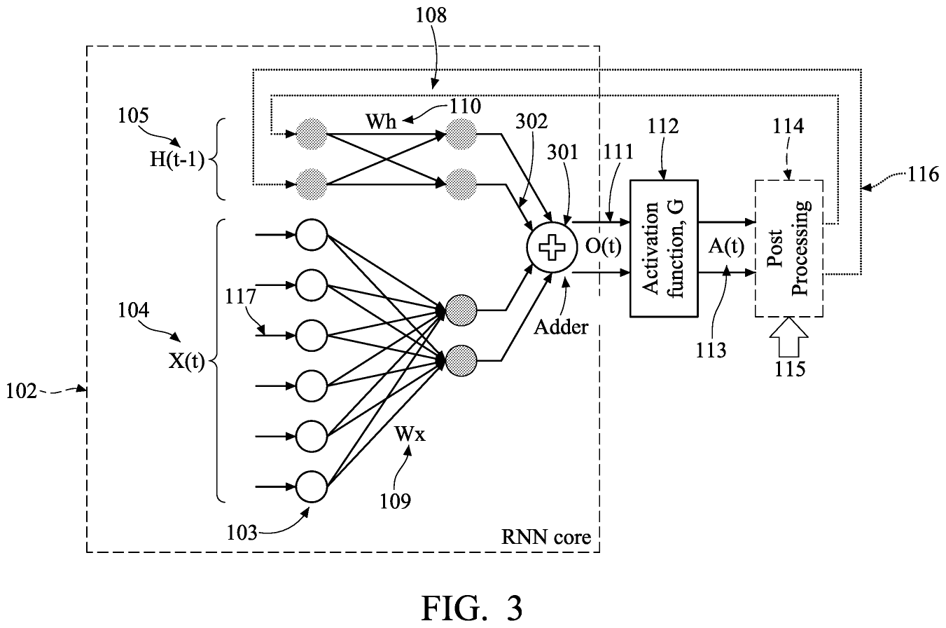

FIG. 3 depicts an RNN core 102 partitioned view based on the time dependence of the inputs, in accordance with some embodiments. The time-delayed hidden vectors H(t−1) 105 may need to be calculated progressively over time. For example, each time-delayed hidden vector H(t−1) 105 from various time steps may not be available at a particular time step, but may need to be calculated serially. This is because the hidden vectors 105 may be based on the activation vectors A(t) 113 from previous timesteps, as discussed above with reference to FIGS. 1 and 2. In contrast, the input vectors X(t) 104 for each timestep may be available initially. This may be the case, for example, in applications such as language translation in which each word in a sentence or page is available in the memory of a device. This is possible in such applications because the input vectors X(t) 104 at various timesteps are not dependent upon signals previously generated by the RNN gate 101.

As illustrated by the input vector X(t) 104 and the time-delayed hidden vector H(t−1) 105 being received by separate hidden layer 108 nodes, the multiplication of the time-delayed hidden vector H(t−1) and the input vector X(t) may be performed even when they are received at the hidden layer 108 independently from one another. In other words, the input vector 104 may be multiplied by the input vector weight matrix Wₓ 109 and be received at the hidden layer 108 at various timesteps. The hidden vectors 105 may be multiplied by the hidden vector weight matrix Wₕ 110 and be received at the hidden layer 108 at differing timesteps than the input vectors 104. The hidden layer 108 can then generate partial sums 302. For example, each partial sum 302 may be generated by multiplying each hidden vector 105 by a corresponding row or column of the hidden vector weight matrix Wₕ 110. The partial sums generated by the hidden vectors 105 at each timestep can then be added (e.g., by an adder 301) together to generate the full sum vector O(t) 111. As discussed above, the activation function block 112 receives the full sum vector O(t) 111 and applies one or more activation functions to the full sum vector O(t) 111, generating the activation vector A(t) 113. The post processing block 115 then receives and processes the activation vector A(t) 113, generating the RNN output signals 116. As discussed above, the processing of the activation vector A(t) 113 may involve applying a digital filter or buffer to the activation vector A(t) 113.

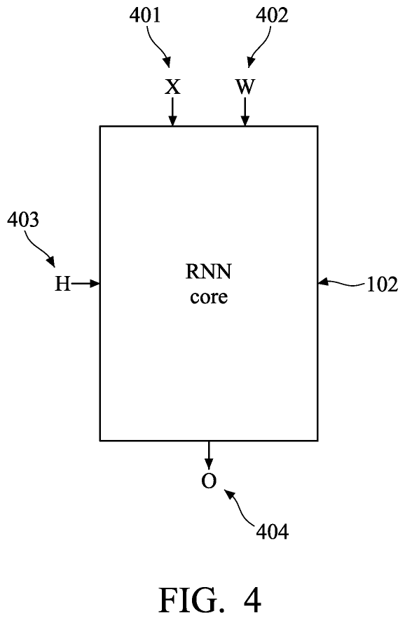

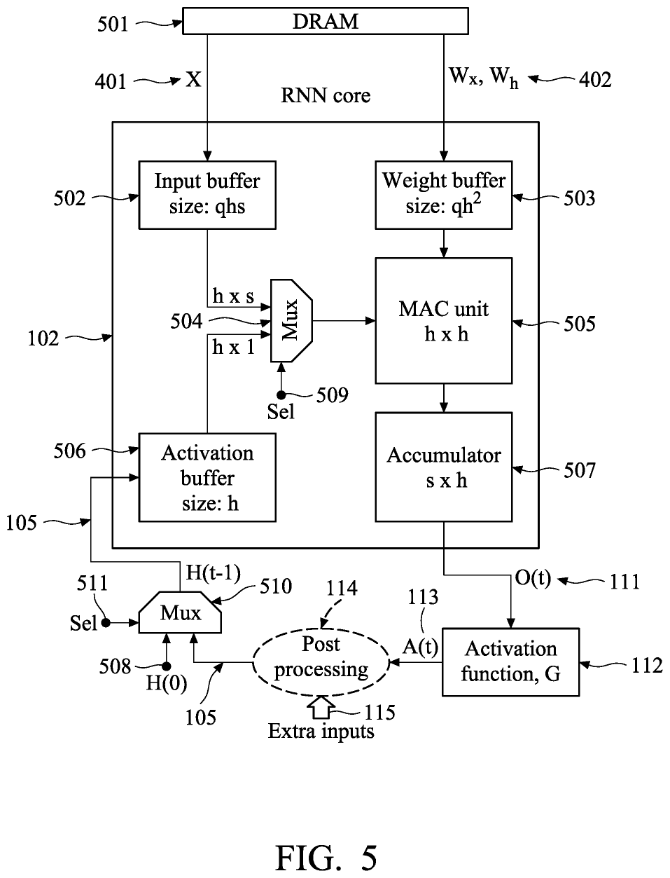

FIG. 4 depicts a functional diagram of an RNN core, in accordance with some embodiments. As depicted in FIG. 4, the RNN core 102 may receive an input matrix 401, a hidden matrix 403, and a combined weight matrix 402. The combined weight matrix 402 includes the input vector weight matrix Wₓ 109 and the hidden vector weight matrix Wₕ 110. For example, the combined weight matrix 402 is a matrix in which the input vector weight matrix Wₓ 109 and the hidden vector weight matrix Wₕ 110 are concatenated. The input matrix 401 includes a plurality of input vectors 104 combined (e.g., “batched”) together. Similarly, the hidden matrix 403 includes a plurality of time-delayed hidden vectors 105. Based on the input matrix 401, the hidden matrix 403, and the combined weight matrix 402, the RNN core 102 generates a full sum matrix 404. The RNN core 102 and its operation are described in greater detail further with respect to FIG. 5.

FIG. 5 depicts an RNN core architecture, in accordance with some embodiments. In the example depicted in FIG. 5, the RNN core 102 is coupled to a neural network memory 501. The RNN core 102 includes an input buffer 502, a weight buffer 503, a first selection device 504 (e.g., a multiplexer), a multiply-accumulate (MAC) unit 505, an activation buffer 506, and an accumulator 507. Prior to the operation of the RNN core 102, the input matrix 401 may be stored in the neural network memory 501. In the example embodiment depicted in FIG. 5, the neural network memory 501 is a dynamic random-access memory (DRAM). In other example embodiments, the neural network memory 501 may be a static random-access memory (SRAM) or another memory type. The input buffer 502 receives the input matrix 401. The input matrix 401 may be divided into multiple segments (e.g., “folds”) for appropriate dimensioning and computation purposes, as discussed further below.

The combined weight matrix 402 is received by the weight buffer 503. The combined weight matrix 402 may be, for example, a matrix including the input vector weight matrix 109 and the hidden vector weight matrix 110 concatenated to one another as discussed above with reference to FIG. 4. The combined weight matrix 402 may be stored in the weight buffer 503 and may also be divided into a plurality of segments (e.g., “folds”). These folds are then distributed to the MAC unit 505 in series to complete matrix multiplication of the folds with corresponding folds of the input matrix 401 and time-delayed hidden vectors 105 received from the first selection device 504.

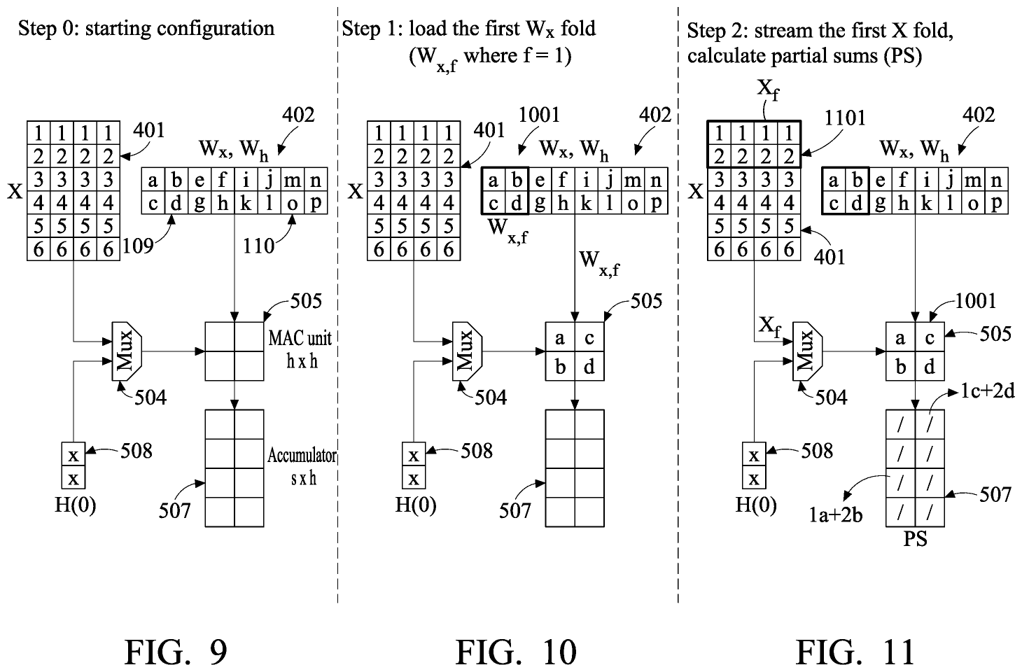

The first selection device 504 is coupled to the input buffer 502 and the activation buffer 506. The first selection device 504 is configured to select from folds of the input matrix 401 within the input buffer 502 and time-delayed hidden vectors 105 within the activation buffer 506 for distribution to the MAC unit 505. The first selection device 504 selects from the input buffer 502 or the activation buffer 506 depending on the value of a first selection signal 509. The selected item (e.g., a fold of the input matrix 401 or a time-delayed hidden vector 105) is then distributed (e.g., “streamed”) through the MAC unit 505 for matrix multiplication with a fold of the combined weight matrix 402 occupying the MAC unit 505. A process by which the matrix multiplication is completed and the generated partial sums are subsequently accumulated is discussed further with respect to FIGS. 9-23.

Based on matrix multiplication at the MAC unit 505, partial sums are generated and stored in the accumulator 507, which is coupled to the MAC unit 505. The accumulator 507 then generates full sum vectors O(t) 111, as described below with respect to FIGS. 9-23. The full sum vectors O(t) 111 are then received at the activation function block 112, which applies an activation function to the full sum vectors O(t) 111 (e.g., sigmoid or hyperbolic tangent), generating activation vectors A(t) 113. The activation vectors A(t) 113 are then received at the post processing block 114 and are processed to generate time-delayed hidden vectors H(t−1) 105. For example, the time-delayed hidden vectors H(t−1) 105 may be generated based on the digital filter or buffer being applied to the activation vectors A(t) 113. The time-delayed hidden vectors H(t−1) 105 include an initial hidden vector H(0) 508. An initial hidden vector 508 may be useful for an initial multiplication with the hidden vector weight matrix 110 to generate a first full sum vector O(t) 111, as described further below.

The initial hidden vector H(0) 508 and subsequent time-delayed hidden vectors H(t−1) 105 are received at a second selection device 510 (e.g., multiplexer). The second selection device 510 also receives a hidden vector selection signal 511. Based on the hidden vector selection signal 511, the second selection device 510 can select from the initial hidden vector H(0) 508 or another time-delayed hidden vector H(t−1) 105. Thus, the value of the hidden vector selection signal 511 may depend on the timestep ‘t’ of the RNN core 102 or on the step in the process of generating a full sum matrix 404.

The dimensions of the individual components of the RNN core 102 may be selected or designed to accommodate the received signals, vectors, and matrices. For example, the dimensions of the input buffer 502 may be appropriate for receiving multiple folds of the input matrix 401. For example, for folds of size h×s, the dimensions of the input buffer 502 may be (h×q)×s, where h is the number of neurons in the hidden layer, s is the maximum sequence length of the application (e.g., the number of time steps necessary to generate a full sum matrix), and q is an integral multiple of the MAC unit 505 capacity (e.g., an integral multiple of the number of folds in the input matrix 401). Thus, the input matrix 401 may include q folds, each having dimensions of h×s.

The dimensions of the MAC unit 505 may be h×h. The MAC unit 505 thus may include a dimension h equal to the dimension h of the folds of the input matrix 401, which is advantageous for matrix multiplication. In the example embodiment depicted in FIG. 5, the weight buffer 503 has dimensions (q×h)×h, or q×h². The weight buffer 503 thus includes q folds of the combined weight matrix 402 of size h×h. Each fold of the combined weight matrix 402 can be loaded into the MAC unit 505 serially, as described further below. The accumulator 507 may have dimensions of s×h and thus be appropriately dimensioned to receive the product of the matrix multiplication of the folds of the combined weight matrix 402 and the folds of the input matrix 401. The activation buffer 506 may have dimensions of 1×h so that it is able to accommodate and distribute the time-delayed hidden vectors 105.

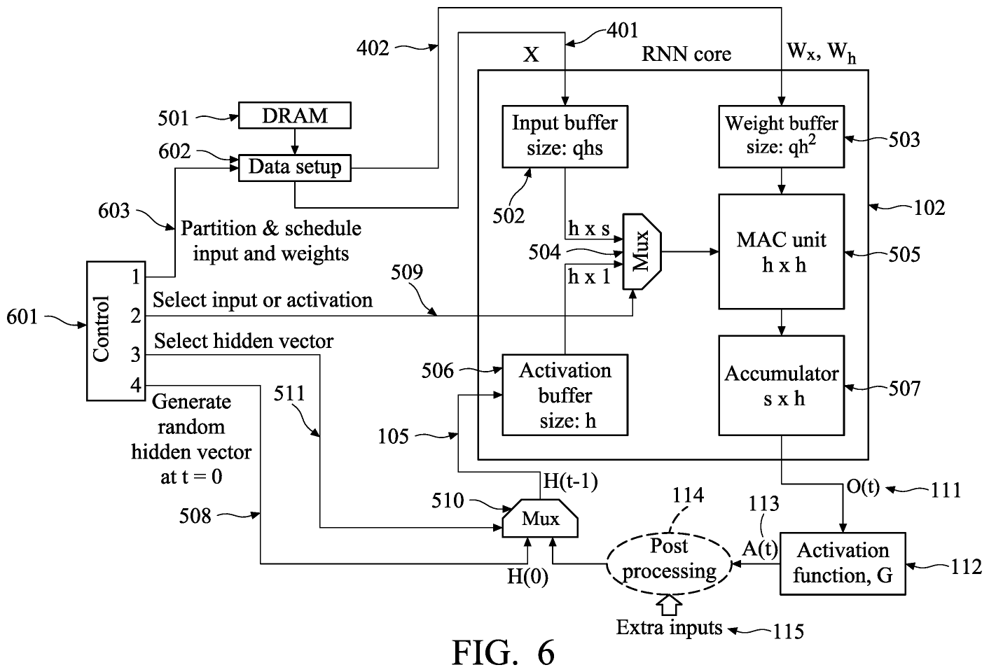

FIG. 6 depicts an architecture (e.g., design) of an RNN core coupled to a control block, in accordance with some embodiments. A control block 601 is coupled to the RNN core 102. The control block 601 can be coupled to a data setup block 602. The data setup block 602 is coupled to the neural network memory (e.g., DRAM) 501 and can receive inputs and weights from the memory 501 (e.g., input vectors, input vector weight matrices). The control block 601 can program the data setup block 602 to partition inputs and weights from the memory 501 and to schedule and send the input matrix 401 to the input buffer 502 and the combined weight matrix 402 to the weight buffer.

The control block 601 is also coupled to the first selection device 504 and can select either folds of the input matrix 401 from the input buffer 502 or time-delayed hidden vectors 105 from the activation buffer 506 to be used as operands in the MAC unit 505. The control block 601 is also coupled to the second selection device 510. The control block 601 can generate the hidden vector selection signal 511 that can be used to select the specific time-delayed hidden vector 105 to be received at the activation buffer 506. The control block 601 may also generate the random hidden vector H(0) 508 to initiate the computation of a first full sum vector O(t). The control block 601 may also be used for time synchronization.

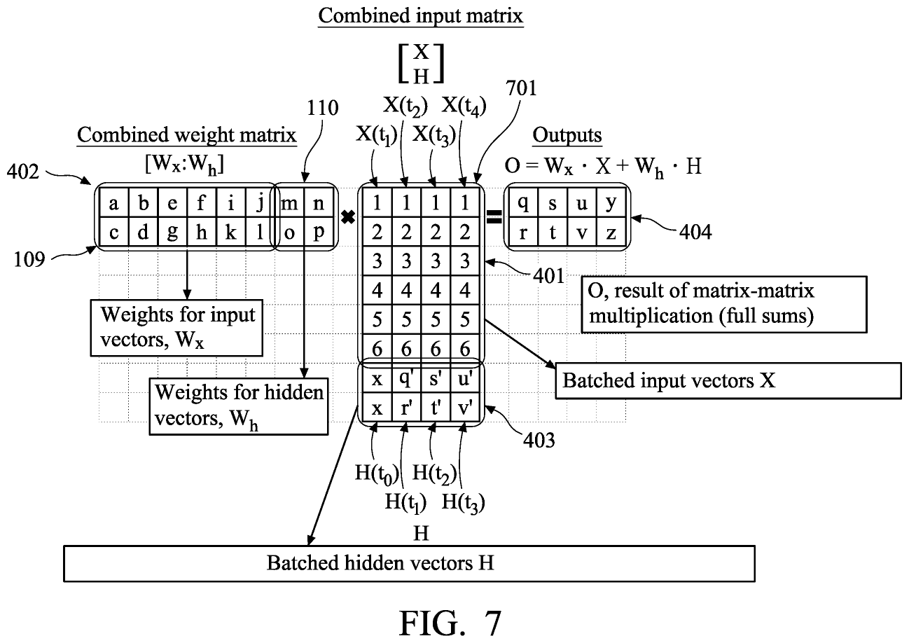

FIG. 7 depicts a matrix multiplication numerical example, in accordance with some embodiments. The matrix multiplication depicted in FIG. 7 may be performed, for example, by the MAC unit 505. In the example embodiment of FIG. 7, the input vector weight matrix Wₓ 109 and the hidden vector weight matrix Wₕ 110 are combined (e.g., concatenated) to form the combined weight matrix 402. The input matrix 401 is also combined with the hidden matrix 403 to form a combined input matrix 701. For example, the input vector at time t=2, X(2), may be combined with the corresponding time-delayed hidden vector at time t=2, H(1). In the example embodiment of FIG. 7, the combined weight matrix 402 is multiplied by the combined input matrix 701 to generate the full sum matrix 404.

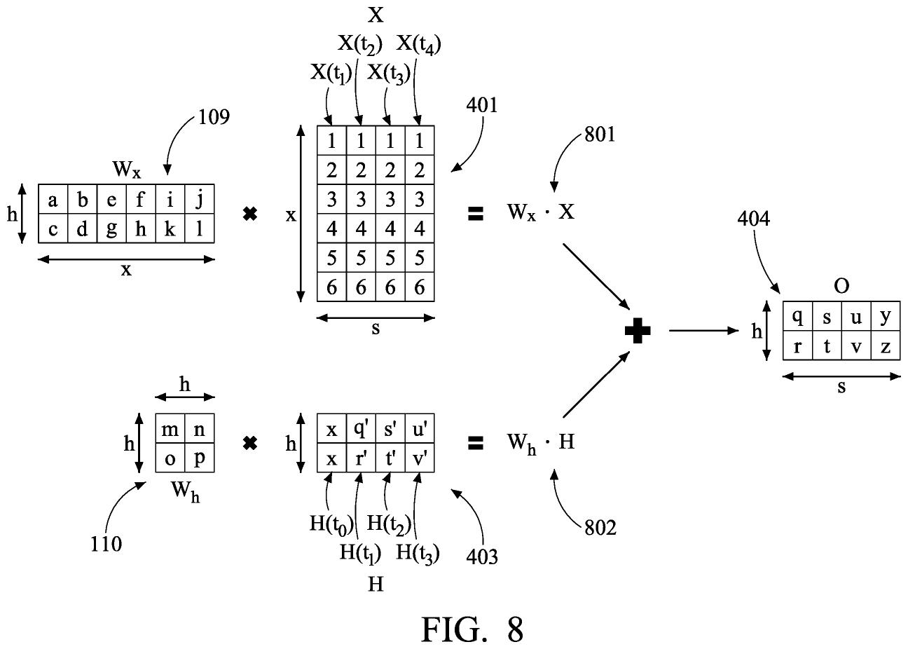

FIG. 8 depicts a decomposed matrix view of a matrix multiplication, in accordance with some embodiments. As depicted in FIG. 8, the input vector weight matrix 109 is multiplied by the input matrix 401 to generate a weighted input matrix Wₓ×X 801. Separately, the hidden vector weight matrix Wₕ 110 is multiplied by the hidden matrix H 403 to generate the weighted hidden matrix Wₕ×H 802. While the multiplication of the input matrix 401 and the hidden matrix 403 with their respective weight matrices (109, 110) may be performed separately from one another, the individual components of the hidden matrix 403 may depend upon the contents of the weighted input matrix 801, as described further below. When the weighted input matrix 801 and the weighted hidden matrix 802 are complete, they are added together to produce the full sum matrix O 404.

FIGS. 9-23 depict steps of an RNN core operation, in accordance with some embodiments. FIG. 9 depicts a starting configuration. As depicted in the starting configuration, the input matrix 401 is coupled to the first selection device 504 and includes a plurality of input vectors 104 (e.g., an input vector for each timestep in a time sequence). The starting configuration of FIG. 9 also includes the combined weight matrix 402, which includes both the input vector weight matrix 109 and the hidden vector weight matrix 110. The combined weight matrix 402 is coupled to the MAC unit 505, which can receive inputs from both the combined weight matrix 402 and the first selection device 504. As discussed above, the MAC unit 505 includes dimensions sufficient to receive folds of the combined weight matrix 402. In the example depicted in FIG. 9, the dimensions of the MAC unit are 2×2, because the number of nodes (e.g., “neurons”) in the hidden layer 108 is two (2). The starting configuration also includes the accumulator 507, which is used to store the outputs (e.g., temporal partial sums and partial sums) of the MAC unit 505, as described further below.

FIG. 10 depicts a first step of loading the first fold of the input vector weight matrix Wₓ into the MAC unit 505. In the example of FIG. 10, the weights included in the first fold 1001 of the combined weight matrix 402 are ‘a’, ‘b’, ‘c’, and ‘d.’ As illustrated in FIG. 11, a second step includes loading (e.g., streaming) a first fold 1101 of the input matrix 401 into the MAC unit 505 for multiplication with the first fold 1001 of the input vector weight matrix 402. As described above, the size of the folds of the input matrix 401 and the combined weight matrix 402 can be selected such that they include a common dimension (two in the examples of FIGS. 9-23) for purposes of matrix multiplication. In the example depicted in FIG. 11, each input vector 104 within the input matrix 401 includes values of ‘1’, ‘2’, ‘3’, ‘4’, ‘5’, and ‘6.’ Thus, the first fold 1101 of the input matrix 401 includes values ‘1’ and ‘2’ for each input vector 104. The MAC unit 505 generates the result of the multiplication of these folds (1001, 1101) as temporal (e.g., incomplete) partial sums. The temporal partial sums generated based on the multiplication of the input vector 104 may be referred to as input vector partial sums. These temporal partial sums are received at and stored by the accumulator 507. Based on the numbers included in the input matrix 401 and the combined weight matrix 402 in the example depicted in FIG. 11, the temporal partial sums stored in the first (left) column of the accumulator 507 after the second step are 1·a+2·b. The temporal partial sums stored in the second (right) column of the accumulator 507 after the second step are 1·c+2·d.

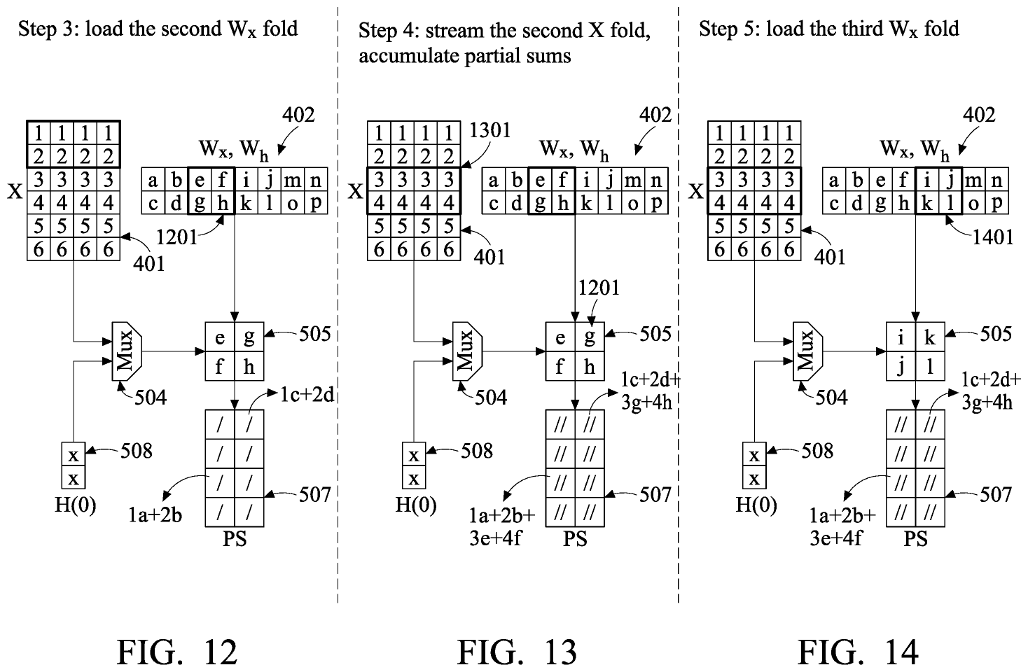

FIG. 12 depicts a third step of loading a second fold of the combined weight matrix 402 into the MAC unit. After the second fold 1201 of the combined weight matrix 402 is loaded into the MAC unit 505, a second fold 1301 of the input matrix 401 is loaded into the MAC unit 505 via the first selection device 504 and multiplied by the second fold 1201 of the combined weight matrix 402. This is the fourth step and is depicted in FIG. 13. Multiplication of the second fold 1201 of the combined weight matrix 402 by the second fold 1301 of the input matrix 401 generates additional temporal partial sums which are added to the partial sums stored in the accumulator. In the example depicted in FIG. 13, these additional temporal sums include the quantity 3·e+4·f, which is added to the values in the first column of the accumulator 507. The additional temporal partial sums also include the quantity 3·g+4·h, which are added to the values in the second column of the accumulator 507. The sum of the temporal partial sums generated up to a particular timestep is the partial sum for that particular timestep. For example, the partial sum available at each element in the second column of the accumulator 507 at time t=2 is 1·c+2·d+3·g+4·h, or the sum of the temporal partial sums generated at time t=1 and time t=2.

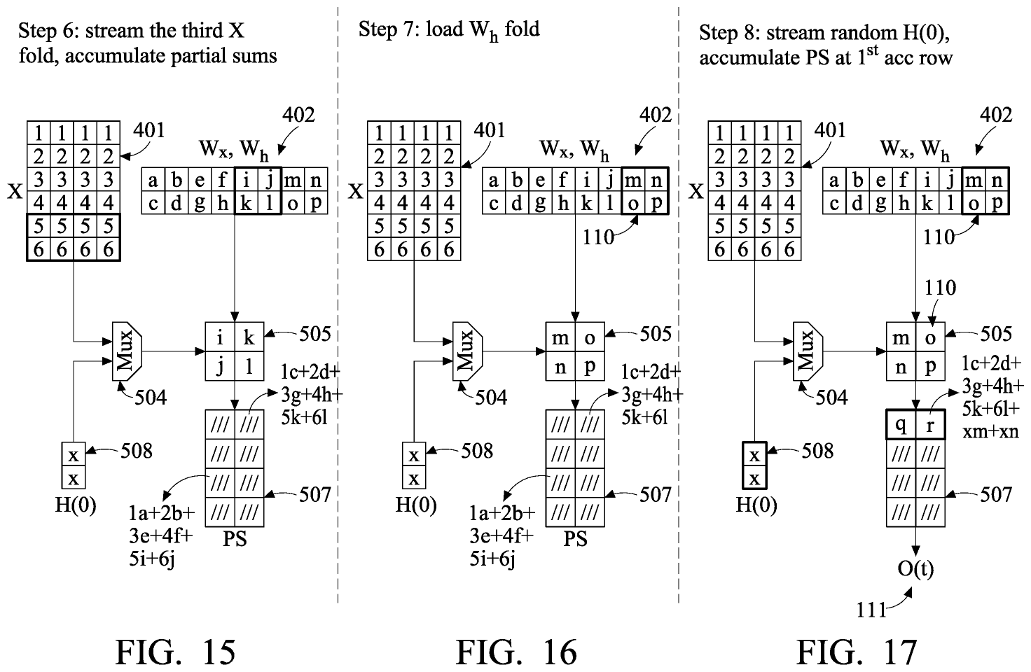

As illustrate in FIGS. 14 and 15, the fifth and sixth steps of the RNN core operation include loading the third fold 1401 of the combined weight matrix 402 into the MAC unit 505 and multiplying this third fold 1401 of the combined weight matrix 402 with the third fold 1501 of the input matrix 401. This multiplication generates additional temporal partial sums 5·i+6 j for addition to the values in the first column of the accumulator 507 and additional temporal partial sums 5·k+6·1 for addition to the values in the second column of the accumulator 507.

FIG. 16 depicts a seventh step of loading a fourth fold of the combined weight matrix. In the example shown in FIG. 16, the fourth fold of the combined weight matrix 402 is the hidden vector weight matrix 110. The hidden vector weight matrix 110 includes the weights ‘m’, ‘n’, ‘o’, and ‘p.’ An eighth step is to load (e.g., stream) the initial hidden vector H(0) 508 into the MAC unit 505 for multiplication by the hidden vector weight matrix 110, as depicted in FIG. 17. The initial hidden vector H(0) may be a random vector. In the example of FIG. 17, the initial hidden vector contains generic values ‘x’ and ‘x.’ The initial hidden vector H(0) 508 is received at the first selection device 504. Prior to the reception of the initial hidden vector 508, the first selection device 504 may switch from the selection of the input matrix 401 to the selection of the initial hidden vector 508 (and the subsequent time-delayed hidden vectors 105, as described further below). The multiplication of the initial hidden vector H(0) 508 produces temporal partial sum x·m+x·n for addition to the value in the first row and first column of the accumulator 507 and temporal partial sum x·o+x·p for addition to the value in the first row and second column of the accumulator 507. The temporal partial sums generated based on the multiplication of the initial hidden vector 508 or other time-delayed hidden vector 105 may be referred to as hidden vector partial sums.

The addition of all the temporal partial sums at each element of the first row of the accumulator 507 results in full sum vector O(t), denoted by values [q, r] in FIG. 17. For example, the full sum value in the first row and second column of the accumulator is defined as ‘r’, and is characterized by equation (3) below:

$$r = 1 \cdot c + 2 \cdot d + 3 \cdot g + 4 \cdot h + 5 \cdot k + 6 \cdot l + x \cdot o + x \cdot p \qquad ( 3 )$$

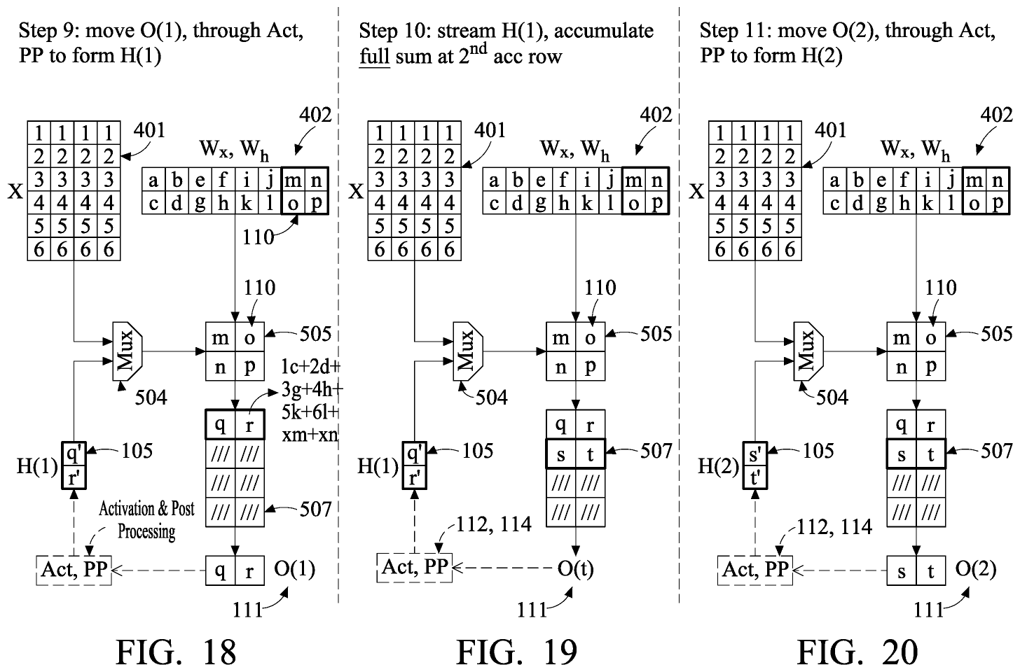

After the first full sum vector O(t) 111 is generated, the RNN core 102 completes a ninth step. The ninth step is illustrated in FIG. 18 and includes applying an activation function to the first full sum vector O(t) 111 and processing the first full sum vector O(t) 111. The activation function is applied by the activation function block 112, and the processing is performed by the post processing block 114. After the activation function is applied to the full sum vector O(t) 111 and the full sum vector O(t) 111 is processed, the post processing block 114 generates the time-delayed hidden vector H(1) 105. For example, the time-delayed hidden vector H(1) 105 may be the result of a digital filter or buffer applied to the full sum vector O(t) 111. The time-delayed hidden vector 105 may be “time-delayed” in the sense that it is utilized to generate temporal partial sums at elements within the accumulator 507 that also include other temporal partial sums generated based on input vectors 104 from later timesteps.

The time-delayed hidden vector H(1) 105 is received at the first selection device 504. The first selection device 504 selects the time-delayed hidden vector H(1) for input at the MAC unit 505. The time-delayed hidden vector H(1) 105 is then multiplied by the hidden vector weight matrix 110 to generate additional temporal partial sums, as shown in step 10 of FIG. 19. These temporal partial sums may be added to the partial sums available at the second row of the accumulator 507 to generate a full sum vector O(2) 111. This full sum vector O(2) 111 may then be received at the activation function block 112, where an activation function is applied to generate the activation vector A(2) (not shown). The activation vector A(2) is then processed at the post processing block to generate the time-delayed hidden vector H(2) 105, as depicted in FIG. 20.

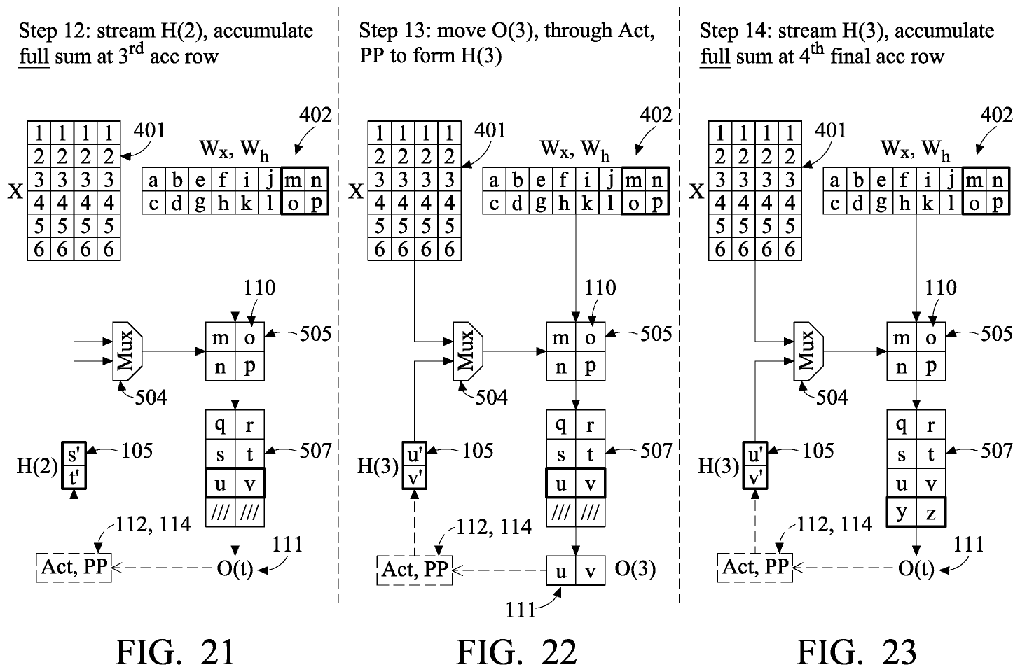

As shown in FIG. 21, the RNN core operation includes a twelfth step of receiving the time-delayed hidden vector H(2) 105 at the first selection device 504 and passing the time-delayed hidden vector H(2) 105 to the MAC unit 505. The time-delayed hidden vector H(2) 105 is then multiplied by the hidden vector weight matrix 110 to generate temporal partial sums. These temporal partial sums can be added to the available partial sums stored in the third row of the accumulator 507 to generate a full sum vector O(3) 111. This full sum vector O(3) 111 may then be received at the activation function block 112, where an activation function is applied to generate the activation vector A(3) 113. The activation vector A(3) is then processed at the post processing block 114 to generate the time-delayed hidden vector H(3) 105, as depicted in FIG. 22.

As shown in FIG. 23, the time-delayed hidden vector H(3) is then received at the first selection device and passed to the MAC unit 505, where it is multiplied by the hidden vector weight matrix 110. The MAC unit 505 then generates additional temporal partial sums, which are added to the fourth row of the accumulator 507 to generate the full sum vector O(4) 111. After each of the full sum vectors O(t) are computed, the entire full sum matrix O may be available.

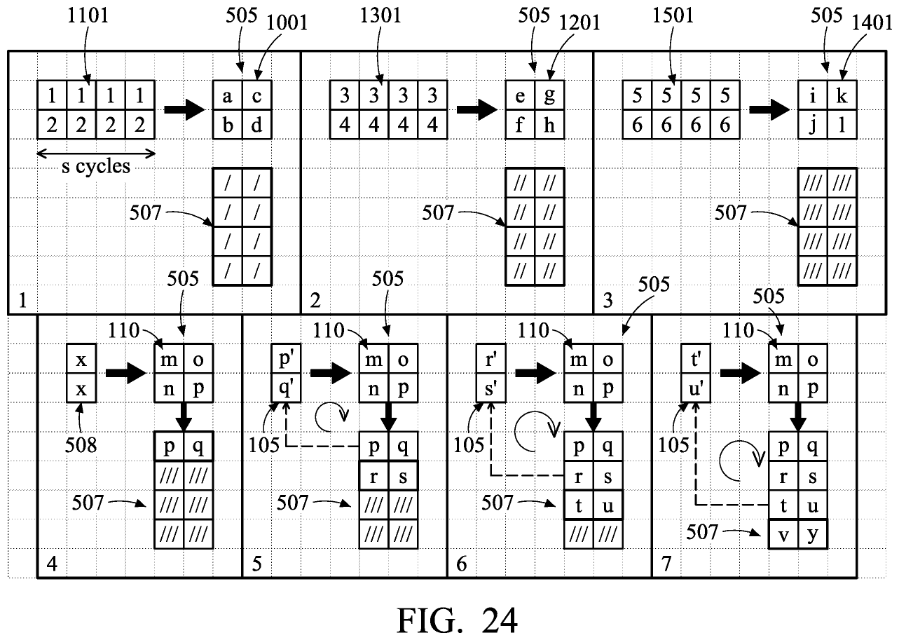

FIG. 24 depicts a summary of an RNN core operation with batched inputs, in accordance with some embodiments. In step one, a starting configuration is shown that includes the first fold 1101 of the input matrix 401, a MAC unit 505, and an accumulator 507. The input matrix 401 may be s columns wide, where s is the number of input vectors 104 in the input matrix 401. In the starting configuration of step 1, the MAC unit 505 contains the first fold 1001 of the combined weight matrix. After the first fold 1101 of the input matrix 401 is multiplied by the corresponding first fold 1001 of the combined weight matrix, the accumulator 507 receives and stores temporal partial sums, which are generated from the multiplication. In the example embodiment of FIG. 24, these temporal partial sums are depicted by the single slashes (‘/’) in step 1.

After the first temporal partial sums are generated, the second fold 1201 of the combined weight matrix is loaded into the MAC unit 505, and is multiplied by the second fold 1301 of the input matrix 401. The multiplication generates additional temporal partial sums. These additional partial sums are received and stored in the accumulator 507, as depicted by the dual slashes in the accumulator 507 of step 2. Step 3 involves the multiplication of the third fold 1501 of the input matrix 401 by the third fold 1401 of the combined weight matrix to generate additional temporal partial sums to add to and store in the accumulator 507. While three steps are illustrated in FIG. 24, the process may include fewer or additional steps and may continue until the multiplication of the entire input matrix by the entire input vector weight matrix is complete.

After the entire input matrix 401 has been multiplied by the entire input vector weight matrix 109, the time-delayed hidden vectors 105 can be multiplied by the hidden vector weight matrix 110. As depicted in step 4 of FIG. 24, the hidden vector weight matrix 110 is loaded into the MAC unit 505. In the example embodiment depicted in FIG. 24, the hidden vector weight matrix 110 includes a single fold. However, in some embodiments the hidden vector weight matrix 110 includes additional folds. The hidden vector weight matrix 110 is then multiplied by the initial hidden vector 508. The initial hidden vector 508 is then multiplied by the hidden vector weight matrix 110 and the resulting temporal partial sums are added to the stored partial sums in the accumulator 507, generating the initial full sum vector 111. An activation function and processing are then applied to this full sum vector 111, generating the time-delayed hidden vector H(t−1) 105. The time-delayed hidden vector H(t−1) 105 is then multiplied by the hidden vector weight matrix 110. This process is repeated until full sums for every element in the full sum matrix is computed, as depicted in steps 5, 6, and 7 of FIG. 24.

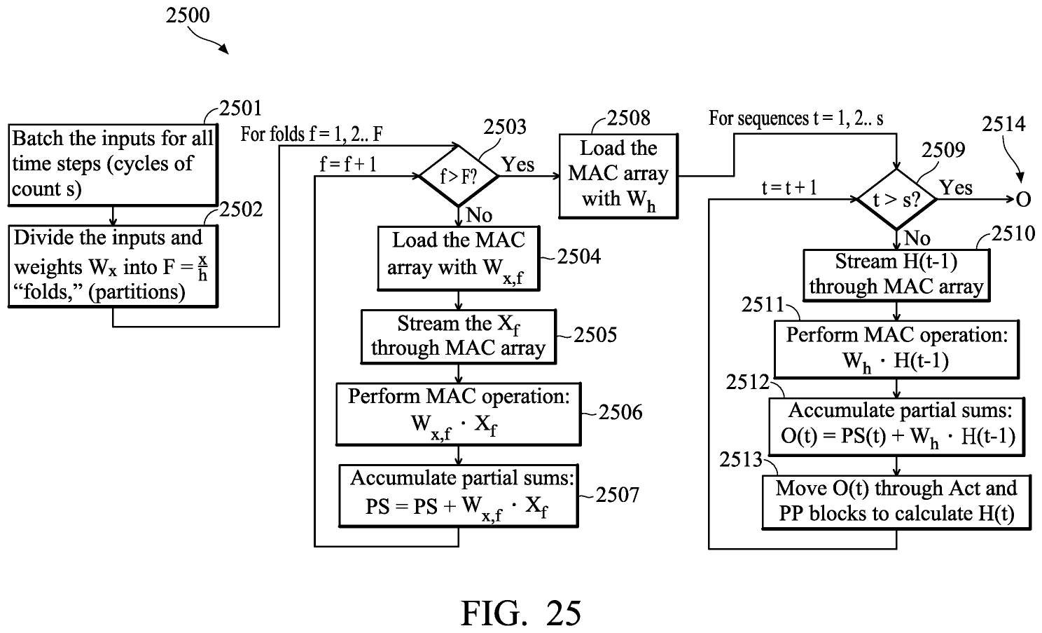

FIG. 25 depicts a flowchart of an RNN core operation with batched inputs in accordance with some embodiments. As shown in block 2501, a plurality of input vectors may be batched to generate an input matrix. Each input vector may be associated with a different timestep. The number of input vectors (e.g., the number of timesteps) in the input matrix is ‘s.’ The plurality of input vectors may be batched within the neural network memory 501, as shown in FIG. 5. After the plurality of input vectors are batched to form an input matrix, the batched input vectors can be divided into a plurality of partitions, or “folds,” as shown in block 2502. The number of folds F may be computed as

$$F = \frac{x}{h} ,$$

where ‘x’ is the length (e.g., number of nodes) of the input vector and ‘h’ is the length of the time-delayed hidden vector. The process of dividing the batched input vectors into a plurality of folds is illustrated in FIGS. 11-15. The input matrix 401 is divided into a plurality of folds. Similarly, the input vector weight matrix 109 is divided into a plurality of folds. This may be accomplished by the input buffer 502, as shown in FIG. 5.

After the batched input vectors are divided into a plurality of folds, a device (e.g., a comparator) determines whether the number of the individual fold “f,” beginning with the first fold (e.g., f=1 for the first fold) is greater than the total number of folds for the batched input vectors (e.g., input matrix). This determination is depicted by block 2503 in FIG. 25. If the number of the individual fold is not greater than the total number of folds of the input matrix, the MAC unit 505 is loaded with the fold of the input vector weight matrix associated with the corresponding fold of the input matrix, as shown in block 2504 of FIG. 24. The corresponding fold of the input vector weight matrix is denoted as W_{x,f}. For example, for the first fold of the input matrix, the corresponding first fold of the input vector weight matrix is denoted as W_{x,1}, as shown in FIG. 10. After the MAC unit is loaded with the corresponding fold of the input vector weight matrix, the input matrix fold X_{f} is “streamed” through the MAC unit, as shown in block 2505. FIG. 11 depicts the input matrix fold X_{f} being streamed through the MAC unit 505. The MAC unit then performs an operation (e.g., matrix multiplication) based on the fold of the input matrix X_{f} and the corresponding fold of the input vector weight matrix W_{x,f}. This operation is illustrated by block 2506.

The MAC unit operation produces temporal partial sums, which are accumulated and added to existing partial sums, as shown in block 2507. The total partial sums can be computed by equation (4) below, where PS is the total partial sum available after the addition of the temporal partial sums W_{x,f}·X_{f} generated by the MAC unit, and PS₋₁ is the computed partial sum from a previous timestep (e.g., the computed total partial sum following the accumulation of the temporal partial sums generated based on the multiplication of the previous folds of the input matrix and the input vector weight matrix). In the example depicted in FIG. 11, the temporal partial sums stored in the first (left) column of the accumulator 507 after the second step are 1·a+2·b, and the temporal partial sums stored in the second (right) column of the accumulator 507 after the second step are 1·c+2·d.

$$P S = P {S}_{- 1} + {W}_{x , f} \cdot {X}_{f} \qquad ( 4 )$$

After the temporal partial sums are accumulated and the total partial sums are computed, the variable “f” associated with the number of the individual fold is increased, as indicated by the line connecting block 2507 to block 2503. The variable “f” may be increased, for example, by software within the RNN system 100. After the variable “f” is increased, it is again compared with the total number of folds “F.” If the number of the individual fold is not greater than the total number of folds, the process is repeated; the next fold of the input vector weight matrix (e.g., the fold associated with f+1) is loaded into the MAC unit, the next fold of the input matrix is streamed through the MAC unit and multiplied by the input vector weight matrix, and partial sums are generated and accumulated to generate new total partial sums. For as long as the number of the individual fold is not greater than the total number of folds of the input matrix, the RNN core operation will remain in this sequence (e.g., “loop”).

If the number of the individual fold f is greater than the total number of folds F, the RNN core operation will proceed to block 2508. As depicted in block 2508, the MAC unit is loaded with the hidden vector weight matrix Wₕ. Loading the MAC unit 505 with the hidden vector weight matrix Wₕ 110 is illustrated in FIG. 16. A time variable t will then be compared to a sequence variable s. As discussed above, the sequence variable s may be the maximum sequence length of the application (e.g., the number of time steps necessary to generate a full sum). The time variable may be initiated as t=1 and may increase incrementally in subsequent timesteps. The initial time variable t may be compared with sequence variable s, as shown in block 2509. Software within the RNN system 100, for example, may compare the initial time variable t with sequence variable s. If the time variable t is not greater than the sequence variable s, the time-delayed hidden vector H(t−1) 105 is streamed through the MAC unit 505, as shown in block 2510. FIG. 19 depicts the time-delayed hidden vector H(1) 105 being streamed through the MAC unit 505. The time-delayed hidden vector H(t−1) is then multiplied by the hidden vector weight matrix in block 2511. This multiplication generates temporal partial sums, which are accumulated as shown in block 2512. As shown in FIGS. 18 and 19, the temporal partial sums generated from the matrix multiplication are added to the previous partial sums ‘///’ to generate full sum vector O(2) having values ‘s’ and ‘t,’ which are stored in the accumulator 507. This process for a timestep ‘t’ is depicted by equation (5) below.

$$O ( t ) = P S ( t ) + {W}_{h} \cdot H ( t - 1 ) \qquad ( 5 )$$

In equation (5), O(t) is the full sum vector associated with timestep t. PS(t) is the total partial sum associated with timestep t. Wₕ·H(t−1) represents the temporal partial sums generated based on the multiplication of the hidden vector weight matrix and the time-delayed hidden vector 105.

As depicted in block 2513, an activation function is then applied to full sum vector O(t) and the full sum vector O(t) is then processed (e.g., at the post processing block). This process is illustrated in FIG. 5. An activation function G is applied to the full sum vector O(t) 111 at the activation function block 112 to generate activation signals 113. The activation signals 113 are then processed by the post processing block 114 and the post processing block 114 generates time delayed hidden vector H(t−1) 105. Thereafter, the time variable t is incremented to correspond to the next timestep, as shown by the arrow from block 2513 to block 2509. The value of time variable t is then compared to the value of sequence variable s. Software within the RNN system 100 may be used to increase the time variable t and to compare the time variable t to the value of sequence variable s. If time variable t is not greater than sequence variable s, the process associated with blocks 2510 through 2513 repeats and additional full sum vectors O(t) are generated. If the value of time variable t is greater than the sequence variable s after it is incremented, each full sum vector for the sequence s has been computed and the full sum matrix O 404 is generated. This process is illustrated in FIGS. 8 and 23. The full sum matrix O 404 is generated after the full sum vector O(t) 111 at each timestep is generated.

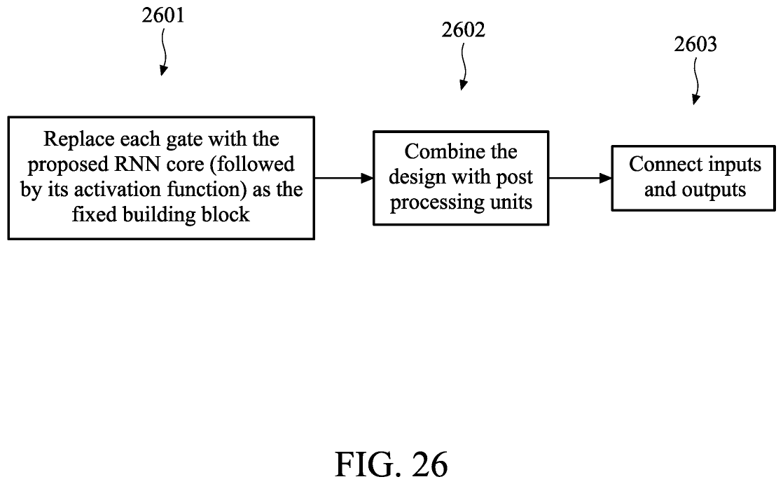

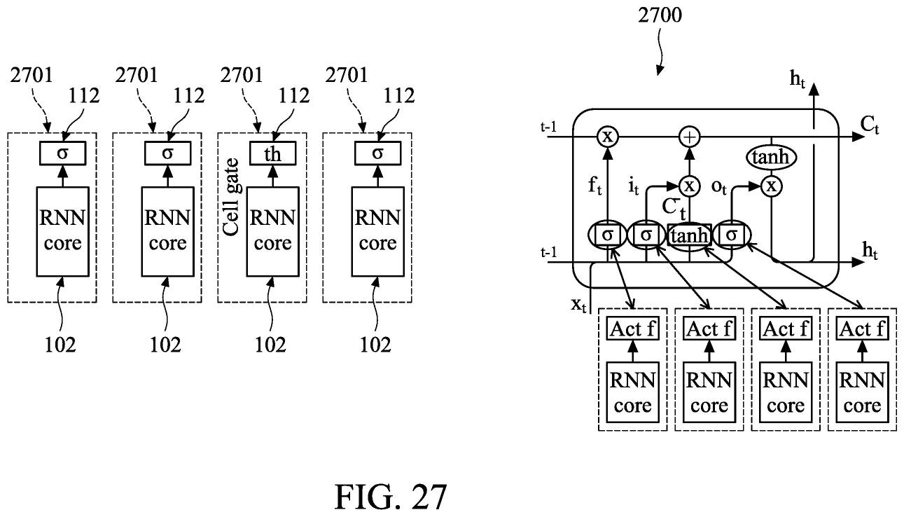

FIG. 26 depicts a flowchart of a hardware implementation of RNN units, in accordance with some embodiments. The steps of the flowchart may be applied to a specific RNN unit. For example, the RNN unit may be a long short-term memory unit or a unit of another type of recurrent neural network. The RNN unit may include one or more gates. A first step 2601 in the flowchart is to replace each gate with an RNN core 102 and an activation function block 112. This replacement is illustrated by FIG. 27. The RNN core 102 may be identical or substantially the same for the replacement of each gate in the RNN unit 2700, while the activation function blocks 112 may differ based on the gate. For example, a sigmoid gate is replaced by an RNN core 102 coupled to a sigmoid function block, while a hyperbolic tangent gate is replaced by an RNN core 102 coupled to a hyperbolic tangent function block. The RNN core 102 and corresponding activation function block 112 may form a replacement gate 2701 and may be collectively referred to as a “cell gate,” or as a “forget gate,” depending on what information is retained and omitted in the operation of the RNN unit 2700.

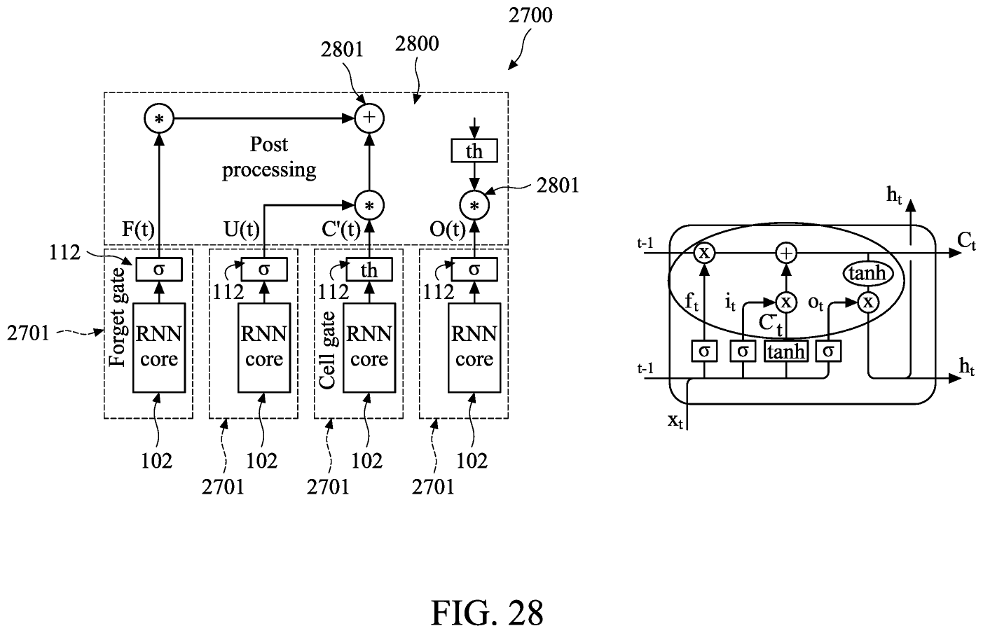

FIG. 26 depicts a second step 2602 in the hardware implementation flowchart of coupling a post processing unit to the replacement gates. As shown in FIG. 28, the post processing unit 2800 is coupled to the replacement gates 2701. Furthermore, the post processing unit 2800 is coupled to the activation function blocks 112 and can apply mathematical operations (e.g., multiplication, addition, convolution) to the outputs of the activation function blocks 112, based on the specific application for which the RNN unit 2700 is used. The post processing unit 2800 may include one or more operational blocks 2801 that are utilized to apply the mathematical operations to the outputs of the activation function blocks 112.

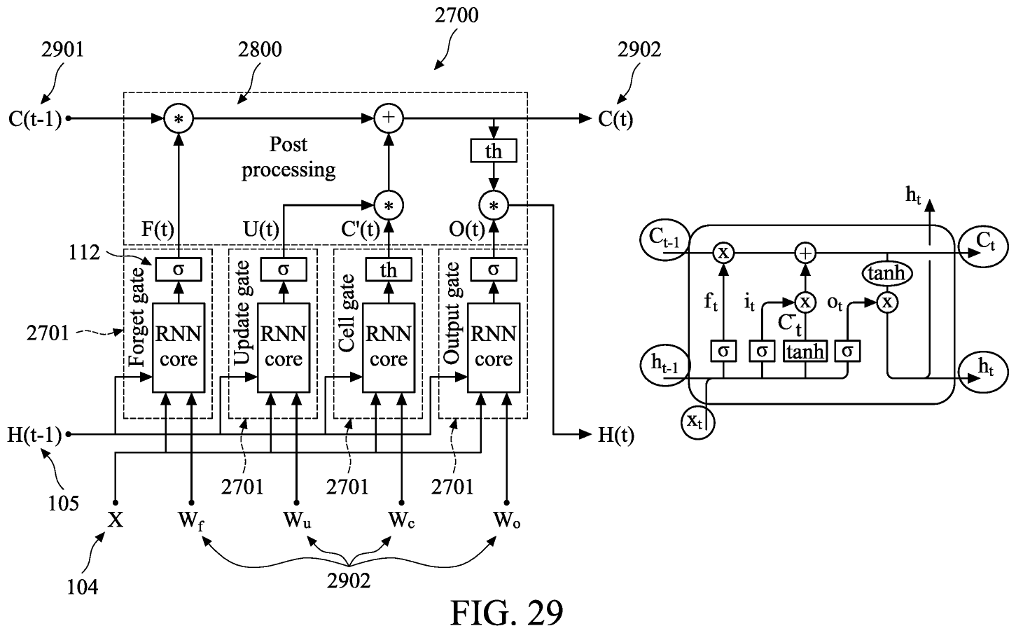

A third step 2603 in the hardware implementation flowchart is to connect inputs and outputs to the RNN unit 2700, as shown in FIG. 29. The inputs to the RNN unit 2700 may include the time delayed hidden vector H(t−1) 105, the input vector X 104, and various weight matrices 2902 (e.g., the hidden vector weight matrix). Other inputs may be included depending on the application and function of the RNN unit 2700. The inputs are coupled to one or more of the RNN cores 102. For example, a single input may be coupled to a plurality of RNN cores 102. The inputs to the RNN unit 2700 may also include a cell state signal C(t) 2902 representing the cell state that has no impact on the function or operation of the replacement gates 2701. This cell state signal C(t) 2901 can be used as an input to the post processing unit 2800 at a subsequent timestep. This is depicted by the time-delayed cell state signal C(t−1) 2901 in FIG. 28.

FIG. 29 represents a complete architecture of an RNN unit 2700. The RNN unit includes four RNN replacement gates 2701 (and thus four RNN cores 102). Each core has corresponding weights (W_{f}, Wᵤ, W_{c}, Wₒ) 2902 and activation function blocks 112. The RNN replacement gates 2701 can work in parallel with one another. The RNN replacement gates 2701 can receive and process the input matrix folds and the time-delayed hidden vectors in accordance with the methods and processes disclosed herein.

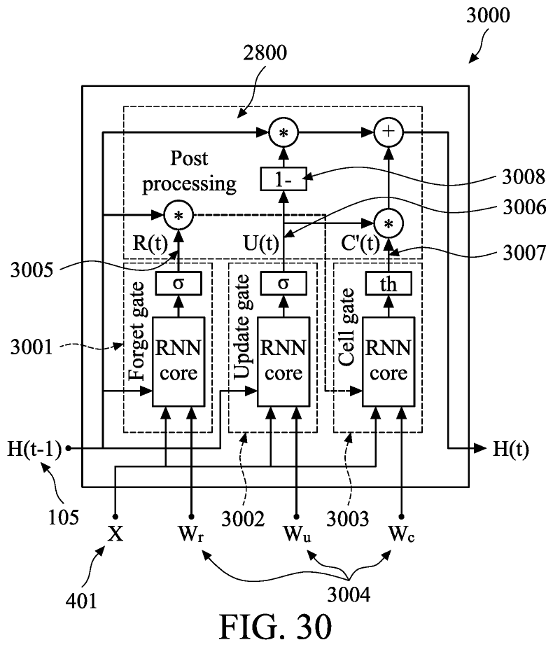

FIG. 30 depicts a gated recurrent unit (GRU) with RNN cores, in accordance with some embodiments. GRUs are unit utilized in artificial neural networks such as RNNs and can be employed in applications including music modeling, speech signal processing, and natural language processing (NLP). The GRU 3000 includes a reset gate 3001, an update gate 3002, and a cell gate 3003. The reset gate 3001, update gate 3002, and cell gate 3003 receive corresponding weight matrices 3004 and the input matrix 401. The reset gate 3001 and update gate 3002 also receive the time-delayed hidden vector 105 as an input. The cell gate 3003, however, receives the output of a multiplication block within the post processing unit 2800, which is the product of the time-delayed hidden vector 105 and a reset gate output signal R(t) 3005. This may cause a time delay in the operation of the GRU 3000 because R(t) 3005 may need to be processed before it can be multiplied by the time-delayed hidden vector H(t−1) 105 and subsequently received at the cell gate 3003. The update gate 3002 generates an update gate output signal U(t) 3006, and the cell gate 3003 generates a cell gate output signal C′(t) 3007. The reset gate output signal R (t) 3005, update gate output signal U(t) 3006, and cell gate output signal C′(t) 3007 can be received by a post processing unit 2800. The post processing unit 2800 may include a plurality of operational blocks that can apply operations to the gate output signals (3005, 3006, 3007) and the time-delayed hidden vector H(t−1) 105. For example, the operational blocks may be configured to perform various mathematical operations on the gate output signals (3005, 3006, 3007) and the time-delayed hidden vector H(t−1) 105, as well as outputs of other operational blocks. In the example embodiment depicted in FIG. 30, the post processing unit includes functional block 3008 which generates a signal that has the value of 1−x, where x is the received input. For example, the output of functional block 3008 in FIG. 30 is 1−U(t). The functions and configurations of the various operational blocks may vary depending on the application for which the GRU is implemented.

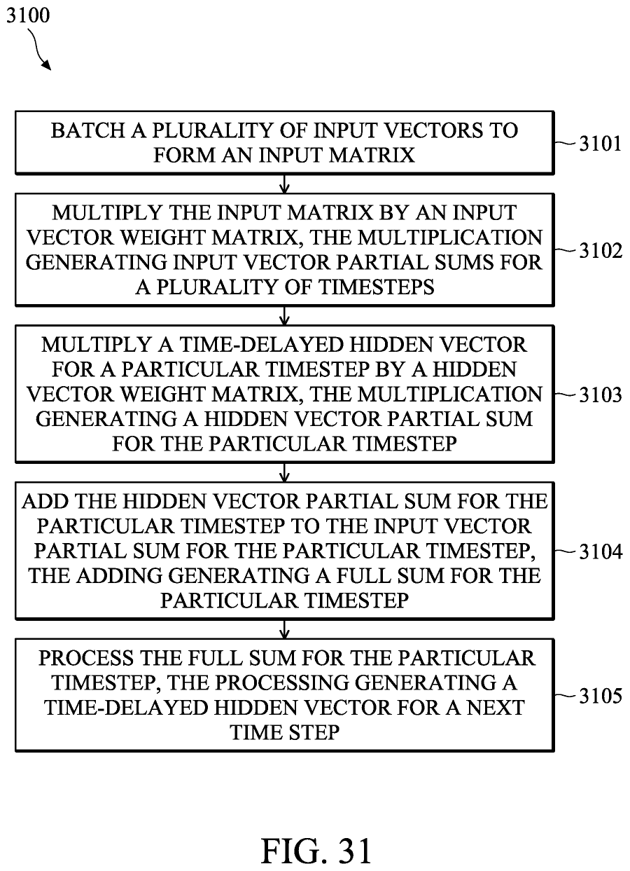

FIG. 31 depicts a method, in accordance with some embodiments. In the example embodiment depicted in FIG. 31, the method 3100 includes a first step 3101 of batching a plurality of input vectors to form an input matrix. The first step 3101 is depicted in FIG. 8. As shown in FIG. 7, the input matrix 401 includes a plurality of input vectors 104. An input vector 104 is illustrated in FIG. 3. The method 3100 further includes a second step 3102 of multiplying the input matrix by an input vector weight matrix, the multiplication generating input vector partial sums for a plurality of timesteps. The second step 3102 is illustrated in FIGS. 9-15. Folds of the input vector weight matrix 402 are serially loaded into the MAC unit 505 and multiplied by corresponding folds of the input matrix 401 to generate a plurality of partial sums in the accumulator 507.

The method 3100 further includes a third step 3103 of multiplying a time-delayed hidden vector for a particular timestep by a hidden vector weight matrix, the multiplication generating a hidden vector partial sum for the particular timestep. The third step 3103 is illustrated in FIG. 18. The time-delayed hidden vector 105 is multiplied by the hidden vector weight matrix 110 and a hidden vector partial sum for the particular timestep is generated. The method 3100 further includes a fourth step 3104 of adding the hidden vector partial sum for the particular timestep to the input vector partial sum for the particular timestep, the adding generating a full sum for the particular timestep. The fourth step 3104 is illustrated in FIGS. 18-19. The hidden vector partial sum is added to the input vector partial sum, generating the full sum vector O(t) 111 in the accumulator 507. The method 3100 further includes a fifth step 3105 of processing the full sum for the particular timestep, the processing generating a time-delayed hidden vector for a next timestep. The fifth step 3105 is illustrated in FIG. 20. The full sum vector O(t) 111 is processed by the post processing block 114 to generate the time-delayed hidden vector 105 for the next timestep (H(2)).

Systems and methods are described herein. In one example, a method includes batching a plurality of input vectors to form an input matrix. The input matrix is multiplied by an input vector weight matrix, the multiplication generating input vector partial sums for a plurality of timesteps. A time-delayed hidden vector for a particular timestep is multiplied by a hidden vector weight matrix, the multiplication generating a hidden vector partial sum for the particular timestep. The hidden vector partial sum for the particular timestep is added to the input vector partial sum for the particular timestep; the adding generating a full sum for the particular timestep. The full sum for the particular timestep is processed, the processing generating a time-delayed hidden vector for a next timestep.

In another example, a neural network includes a multiply-accumulate (MAC) unit. The MAC unit is configured to receive an input matrix and an input vector weight matrix. The MAC unit multiplies the input matrix by the input vector weight matrix. The multiplication generates input vector partial sums. The MAC unit receives time-delayed hidden vectors and a hidden vector weight matrix and multiplies the time-delayed hidden vectors and the hidden vector weight matrix. The multiplication generates hidden vector partial sums. The neural network further includes an accumulator coupled to the MAC unit. The accumulator is configured to accumulate and add the input vector partial sums and the hidden vector partial sums. The addition generates a plurality of full sum vectors. The neural network is configured to generate the time-delayed hidden vectors based on the plurality of full sum vectors. The neural network further includes a first selection device coupled to the MAC unit. The first selection device is configured to select between the input matrix and the time-delayed hidden vectors for reception at the MAC unit.

In another example, a recurrent neural network (RNN) core includes an input buffer configured to receive an input matrix from a memory and to store the input matrix. The input matrix includes a plurality of input vectors. The RNN core further includes a weight buffer configured to receive a weight matrix from the memory and store the weight matrix. The RNN core also includes a multiply-accumulate (MAC) unit. The MAC unit is coupled to the input buffer and the weight buffer. The MAC unit is configured to receive a fold of the input matrix and a corresponding fold of the weight matrix. The MAC unit multiplies the fold of the input matrix by the corresponding fold of the weight matrix. This multiplication generates an input vector partial sum.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

What is claimed is:

1. A method comprising:
batching a plurality of input vectors to form an input matrix;
multiplying the input matrix by an input vector weight matrix, the multiplication generating input vector partial sums for a plurality of timesteps;
multiplying a time-delayed hidden vector for a particular timestep by a hidden vector weight matrix, the multiplication generating a hidden vector partial sum for the particular timestep;
adding the hidden vector partial sum for the particular timestep to the input vector partial sum for the particular timestep, the adding generating a full sum for the particular timestep; and
processing the full sum for the particular timestep, the processing generating a time-delayed hidden vector for a next time step.

2. The method of claim 1, further comprising repeating the steps of:
multiplying the time-delayed hidden vector by the hidden vector weight matrix;
adding the hidden vector partial sum to the input vector partial sum; and
processing the full sum for the particular timestep;
for each timestep in a time sequence until a full sum for each timestep in the time sequence is generated.

3. The method of claim 1, wherein the input matrix comprises a plurality of input matrix folds and the input vector weight matrix comprises a plurality of input vector weight matrix folds.

4. The method of claim 3, wherein multiplying the input matrix by the input vector weight matrix comprises multiplying each fold of the input matrix by a corresponding fold of the input vector weight matrix.

5. The method of claim 1, wherein the multiplication of the input matrix by the input vector weight matrix and the multiplication of the time-delayed hidden vector by the hidden vector weight matrix are performed by a multiply-accumulate (MAC) unit.

6. The method of claim 5, further comprising receiving, at the MAC unit, the input vector weight matrix or the hidden vector weight matrix.

7. The method of claim 6, further comprising:
based on a reception of the input vector weight matrix at the MAC unit, selecting the input matrix for multiplication by the input vector weight matrix; and
based on a reception of the hidden vector weight matrix at the MAC unit, selecting the time-delayed hidden vector for multiplication by the hidden vector weight matrix.

8. The method of claim 7, wherein the selection of the input matrix and the selection of the time-delayed hidden vectors are performed by a first selection device.

9. The method of claim 1, wherein the time-delayed hidden vectors comprise an initial vector, the initial vector being a random vector.

10. The method of claim 1, further comprising combining the input vector weight matrix and the hidden vector weight matrix to form a combined weight matrix.

11. The method of claim 1, further comprising receiving the input matrix, the input vector weight matrix, and the hidden vector weight matrix from a memory.

12. The method of claim 1, wherein the memory is a dynamic random-access memory (DRAM).

13. A neural network comprising:
a multiply-accumulate (MAC) unit configured to:
receive an input matrix and an input vector weight matrix;
multiply the input matrix by the input vector weight matrix, the multiplication generating input vector partial sums;
receive time-delayed hidden vectors and a hidden vector weight matrix; and
multiply the time-delayed hidden vectors and the hidden vector weight matrix, the multiplication generating hidden vector partial sums;
an accumulator coupled to the MAC unit, the accumulator configured to accumulate and add the input vector partial sums and the hidden vector partial sums, the addition generating a plurality of full sum vectors;
wherein the neural network is configured to generate the time-delayed hidden vectors based on the plurality of full sum vectors; and
a first selection device coupled to the MAC unit, the first selection device configured to select between the input matrix and the time-delayed hidden vectors for reception at the MAC unit.

14. The neural network of claim 13, wherein multiplying the input matrix by the input vector weight matrix comprises:
loading one of a plurality of folds of the input vector weight matrix into the MAC unit;
serially multiplying each of a plurality of folds of the input vector by the fold of the input vector weight matrix;
loading a next fold of the plurality of folds of the input vector weight matrix into the MAC unit; and
repeating the serial multiplication and the loading of the next fold until the entire input vector has been multiplied by the input vector weight matrix.

15. The neural network of claim 13, further comprising:
an input buffer coupled to the first selection device, the input buffer configured to store the input matrix; and
a weight buffer coupled to the MAC unit, the weight buffer configured to store the input vector weight matrix and the hidden vector weight matrix.

16. The neural network of claim 13, further comprising an activation function device configured to apply an activation function to the full sum vectors.

17. The neural network of claim 13, further comprising an activation buffer coupled to the first selection device, the activation buffer configured to store the time-delayed hidden vectors.

18. The neural network of claim 17, wherein the time-delayed hidden vectors comprise an initial vector, the initial vector being a random vector.

19. The neural network of claim 18, further comprising a second selection device coupled to the activation buffer and the activation function device, the second selection device configured to select between the initial vector and a separate time-delayed hidden vector for reception at the activation buffer.

20. A recurrent neural network (RNN) core comprising:
an input buffer configured to receive an input matrix from a memory and store the input matrix, the input matrix including a plurality of input vectors;
a weight buffer configured to receive a weight matrix from the memory and store the weight matrix; and
a multiply-accumulate (MAC) unit coupled to the input buffer and the weight buffer, the MAC unit configured to receive a fold of the input matrix and a corresponding fold of the weight matrix and to multiply the fold of the input matrix by the corresponding fold of the weight matrix, the multiplication generating an input vector partial sum.
